(19) United States
(12) Patent Application Publication
(10) Pub. No.: US 2013/0067432 A1
(43) Pub. Date: Mar. 14, 2013

(54) APPLICATION DEVELOPMENT TOOLKIT

(71) Applicants: Daniel Feies, Redmond, WA (US); Jared Russell, Redmond, WA (US); Adam Czeisler, Redmond, WA (US)

(72) Inventors: Daniel Feies, Redmond, WA (US); Jared Russell, Redmond, WA (US); Adam Czeisler, Redmond, WA (US)

(73) Assignee: MICROSOFT CORPORATION, Redmond, WA (US)

(21) Appl. No.: 13/230,766

(22) Filed: Sep. 12, 2011

(51) Int. Cl. G06F 9/44

(52) U.S. Cl. 717/107

(57) ABSTRACT

The present disclosure describes an application development toolkit that includes a memory device configured to store programming constructs of a scripting language. The programming constructs may be configured to define an application. The application development toolkit includes a processing device configured to dynamically generate, in the memory device, an abstract tree structure including at least a portion of the programming constructs that define logic components of the application. The processing device is further configured to build a user interface for the application by concatenating user interface components received from the at least a portion of the programming constructs included in the abstract tree structure.

### TECHNICAL FIELD

This disclosure pertains to an application development toolkit configured to enable generation of an application using core, services, and user interface components.

### BACKGROUND

Web applications are applications that are coded in a browser-supported language, e.g., hypertext markup language (HTML), JavaScript, and the like. A user will typically access web applications using a browser over a network. Web applications are popular due to the ubiquity of clients and because they are centrally updated at the host, eliminating the need for local deployment and update. Common web applications include webmail, chat, online retail sales, online auctions, blogs, online discussion boards, and the like.

Native applications, by contrast, are applications that are coded in an operating system supported language, e.g., C, C++, and the like. Native applications rely on the operating system to execute the native applications' code, resulting in applications that tend to be more functional and more responsive than corresponding web applications. The user typically may access native applications locally on the clients. The user may maintain native applications by installing available updates to a memory device local to the client. Manufacturers often initially install native applications before shipping the product, particularly in mobile communication devices.

Developers often seek tools that facilitate the design and development of both web applications and native applications.

### SUMMARY

The following is a summary to present some aspects and concepts associated with an exemplary application development toolkit as a prelude to the more detailed description of the same presented below. The summary does not identify key or critical elements nor does it delineate the scope of the exemplary application development toolkit.

The present disclosure describes an application development toolkit that, in one embodiment, includes a memory device configured to store programming constructs of a scripting language. The programming constructs may define an application. The application development toolkit includes a processing device configured to dynamically generate, in the memory device, an abstract tree structure including at least a portion of the programming constructs that define logic components of the application. The processing device is further configured to build a user interface for the application by concatenating user interface components received from the at least a portion of the programming constructs included in the abstract tree structure.

Additional aspects and advantages of an exemplary application development toolkit will be apparent from the following detailed description that proceeds with reference to the accompanying drawings.

### DRAWINGS DESCRIPTION

FIG. 1 is a block diagram of a system 100 for implementing an exemplary application development toolkit.

FIG. 2 is a simplified block diagram of the exemplary application development toolkit shown in FIG. 1.

FIG. 3 is an abstract tree structure associated with the exemplary application development toolkit shown in FIG. 1.

FIG. 4 is an illustration of a user interface for the abstract tree structure shown in FIG. 3.

FIG. 5 is a simplified flow diagram illustrating a method of generating an application using the exemplary application development toolkit shown in FIG. 1.

### DETAILED DESCRIPTION

Exemplary application development toolkit provides developers tools that facilitate the design and development of applications. Exemplary application development toolkit includes a memory device configured to store programming constructs of a scripting language. The programming constructs may be configured to define an application. The application development toolkit further includes a processing device configured to dynamically generate, in the memory device, an abstract tree structure including at least a portion of the programming constructs that define logic components of the application. The processing device is further configured to build a user interface for the application by concatenating user interface components received from the at least a portion of the programming constructs included in the abstract tree structure.

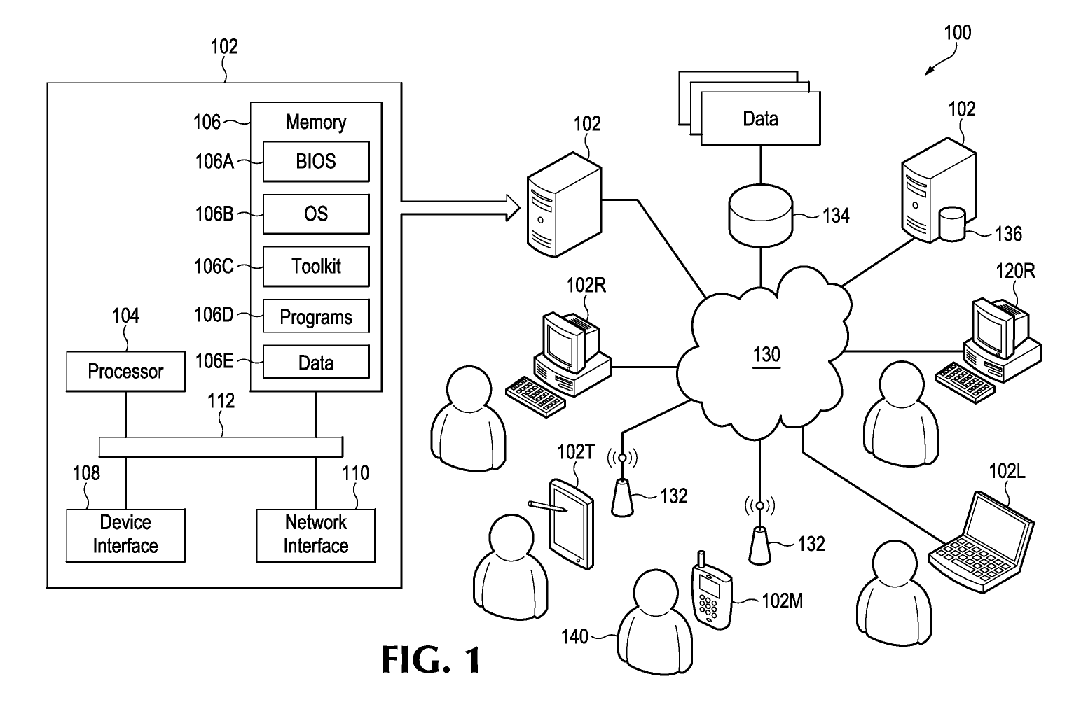

FIG. 1 is a block diagram of a system 100 for implementing the exemplary application development toolkit. Referring to FIG. 1, the system 100 includes a computing device 102 that may execute instructions of application programs or modules stored in system memory, e.g., memory 106. The application programs or modules may include objects, components, routines, programs, instructions, data structures, and the like that perform particular tasks functions or that implement particular abstract data types. Some or all of the application programs may be instantiated at run time by a processing device 104. A person of ordinary skill in the art will recognize that many of the concepts associated with the exemplary application development toolkit may be implemented as computer instructions, firmware, or software in any of a variety of computing architectures, e.g., computing device 102, to achieve a same or equivalent result.

Moreover, a person of ordinary skill in the art will recognize that the exemplary application development toolkit may be implemented on other types of computing architectures, e.g., general purpose or personal computers, hand-held devices, mobile communication devices, multi-processor systems, microprocessor-based or programmable consumer electronics, minicomputers, mainframe computers, application specific integrated circuits, and like. For illustrative purposes only, system 100 is shown in FIG. 1 to include computing devices 102, geographically remote computing devices 102R, tablet computing device 102T, mobile computing device 102M, and laptop computing device 102L.

Similarly, a person of ordinary skill in the art will recognize that the exemplary application development toolkit may be implemented in a distributed computing system in which various computing entities or devices, often geographically remote from one another, e.g., computing device 102 and remote computing device 102R, perform particular tasks or execute particular objects, components, routines, programs, instructions, data structures, and the like. For example, the exemplary application development toolkit may be implemented in a server/client configuration (e.g., computing device 102 may operate as a server and remote computing device 102R may operate as a client). In distributed computing systems, application programs may be stored in local memory 106, external memory 136, or remote memory 134. Local memory 106, external memory 136, or remote memory 134 may be any kind of memory known to a person of ordinary skill in the art including random access memory (RAM), flash memory, read only memory (ROM), ferroelectric RAM, magnetic storage devices, optical discs, and the like.

The computing device 102 comprises processing device 104, memory 106, device interface 108, and network interface 110, which may all be interconnected through bus 112. The processing device 104 represents a single, central processing unit, or a plurality of processing units in a single or two or more computing devices 102, e.g., computing device 102 and remote computing device 102R. The local memory 106, as well as external memory 136 or remote memory 134, may be any type memory device including any combination of RAM, flash memory, ROM, ferroelectric RAM, magnetic storage devices, optical discs, and the like. The local memory 106 may include a basic input/output system (BIOS) 106A with routines to transfer data, including data 106E, between the various elements of the computer system 100. The local memory 106 also may store an operating system (OS) 106B that, after being initially loaded by a boot program, manages other programs in the computing device 102. The local memory 106 may store routines or programs, e.g., the exemplary application development toolkit 106C, and/or the programs or applications 106D generated using the toolkit. The exemplary application development toolkit 106C may make use of the OS 106B by making requests for services through a defined application program interface (API). The exemplary application development toolkit 106C may be used to enable the generation or creation of any application program designed to perform a specific function directly for a user or, in some cases, for another application program. Examples of application programs include word processors, database programs, browsers, development tools, drawing, paint, and image editing programs, communication programs, and tailored applications as the present disclosure describes in more detail below, and the like. Users may interact directly with the OS 106B through a user interface such as a command language or a user interface displayed on a monitor (not shown).

Device interface 108 may be any one of several types of interfaces. The device interface 108 may operatively couple any of a variety of devices, e.g., hard disk drive, optical disk drive, magnetic disk drive, or the like, to the bus 112. The device interface 108 may represent either one interface or various distinct interfaces, each specially constructed to support the particular device that it interfaces to the bus 112. The device interface 108 may additionally interface input or output devices utilized by a user to provide direction to the computing device 102 and to receive information from the computing device 102. These input or output devices may include keyboards, monitors, mice, pointing devices, speakers, stylus, microphone, joystick, game pad, satellite dish, printer, scanner, camera, video equipment, modem, monitor, and the like (not shown). The device interface 108 may be a serial interface, parallel port, game port, firewire port, universal serial bus, or the like.

A person of skill in the art will recognize that the system 100 may use any type of computer readable medium accessible by a computer, such as magnetic cassettes, flash memory cards, digital video disks, cartridges, RAM, ROM, flash memory, magnetic disc drives, optical disc drives, and the like.

Network interface 110 operatively couples the computing device 102 to one or more remote computing devices 102R, tablet computing devices 102T, mobile computing devices 102M, and laptop computing devices 102L, on a local or wide area network 130. Computing devices 102R may be geographically remote from computing device 102. Remote computing device 102R may have the structure of computing device 102, or may operate as server, client, router, switch, peer device, network node, or other networked device and typically includes some or all of the elements of computing device 102. Computing device 102 may connect to the local or wide area network 130 through a network interface or adapter included in the interface 110. Computing device 102 may connect to the local or wide area network 130 through a modem or other communications device included in the network interface 110. Computing device 102 alternatively may connect to the local or wide area network 130 using a wireless device 132. The modem or communications device may establish communications to remote computing devices 102R through global communications network 130. A person of ordinary skill in the art will recognize that application programs or modules 106C might be stored remotely through such networked connections.

The present disclosure may describe some portions of the exemplary application development toolkit using algorithms and symbolic representations of operations on data bits within a memory, e.g., memory 106. A person of skill in the art will understand these algorithms and symbolic representations as most effectively conveying the substance of their work to others of skill in the art. An algorithm is a self-consistent sequence leading to a desired result. The sequence requires physical manipulations of physical quantities. Usually, but not necessarily, these quantities take the form of electrical or magnetic signals capable of being stored, transferred, combined, compared, and otherwise manipulated. For simplicity, the present disclosure refers to these signals as bits, values, elements, symbols, characters, terms, numbers, or like. The terms are merely convenient labels. A person of skill in the art will recognize that terms such as computing, calculating, generating, loading, determining, displaying, or like refer to the actions and processes of a computing device, e.g., computing device 102. The computing device 102 may manipulate and transform data represented as physical electronic quantities within a memory into other data similarly represented as physical electronic quantities within the memory.

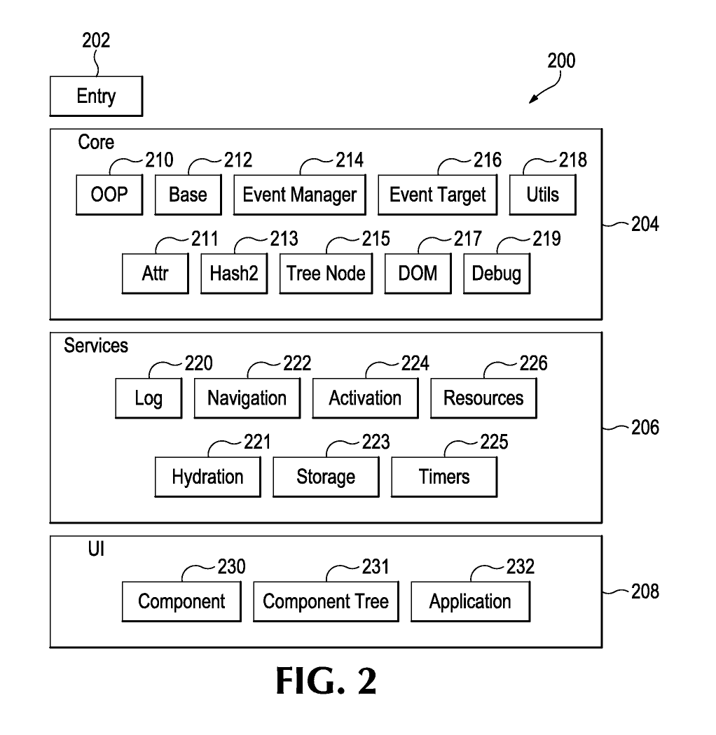

FIG. 2 is a simplified block diagram of the exemplary application development toolkit 106C shown in FIG. 1. Referring to FIG. 2, the exemplary development toolkit 200 may include modules that enable the generation of tailored applications. Tailored applications, as the present disclosure describes herein, refer to hybrid applications having characteristics of both web applications and native applications. Like web applications, tailored applications may be coded in browser-supported language, e.g., JavaScript. Unlike web applications, however, tailored applications take advantage of the OS capabilities of a computing device similarly to native applications. Tailored applications may generate animated views, scene or image changes such as fade, fade to black, dissolved, panning from one person to another or from one scene to another, and like digital effects. Tailored applications may allow for the sharing of state information associated with the various modules without needing to refresh the host. Exemplary modules may be self-contained, encapsulated, and loosely-coupled to allow for tailored applications to be easily maintained. Each module may be configured to enable testing its corresponding functionality by enabling simulation of various entry points, by enabling mocking or mimicking of dependencies to other modules, and by testing an application programming interface (API) and other functionality for each or a combination of modules without testing the entire application. To improve performance, the exemplary application development toolkit 200 may include modules that build the user interface from subsets of available modules only.

Modules, as described herein, refer to any programming construct, abstract or otherwise, including objects, components, routines, programs, instructions, data structures, and/or the like that define a compilation of attributes and behaviors, that bring together data with the procedures to manipulate them, that perform particular tasks or functions, or that implement particular abstract data types. Modules may be written in any programming language known to a person of ordinary skill in the art, including any scripting language such as JavaScript, VB Script, Jscript, XUL, Ajax, and the like. Some or all of the modules may be instantiated at run time by, e.g., a processing device 104 (FIG. 1).

Exemplary application development toolkit 200 may dynamically create content for tailored applications in response to an abstract tree structure that represents at least some of the modules the present disclosure describes in detail below. Exemplary application development toolkit 200 may include modules that build and maintain the abstract tree structure in response to one or more conditions, for example, the plurality of entry points to the application, a universal reference locator for the application, a state of an operating system associated with the application, a state of the application, an action of a user, a hardware configuration of the computing device, or the like.

Exemplary application development toolkit 200 may be logically organized as three groups of modules: core modules 204, services modules 206, and user interface modules 208. Core modules 204 may be those modules used to create tailored applications. Services modules 206 may be those modules that are optional to generate or create tailored applications. User interface modules 208 may include modules responsible for the generation of user interfaces for tailored applications. Together, core modules 204, services modules 206, and user interface modules 208 provide a common framework from which to generate, design, or define tailored applications.

The present disclosure initially focuses on a description of three specific modules, namely, component tree module 231 and component module 230 included in user interface modules 208 and the tree node module 215 included in core modules 204.

A tree may be an abstract structure that uses a set of linked nodes to represent relationships between modules, objects, units, entities, elements, individuals, or the like, each represented by a node. Each node in a tree has zero or more child nodes, which are below it in the tree (by convention, trees are graphically represented growing downwards). A node that has a child is called the child's parent node. A node has at most one parent. A node without a parent is termed the root node, typically shown at the top of the tree.

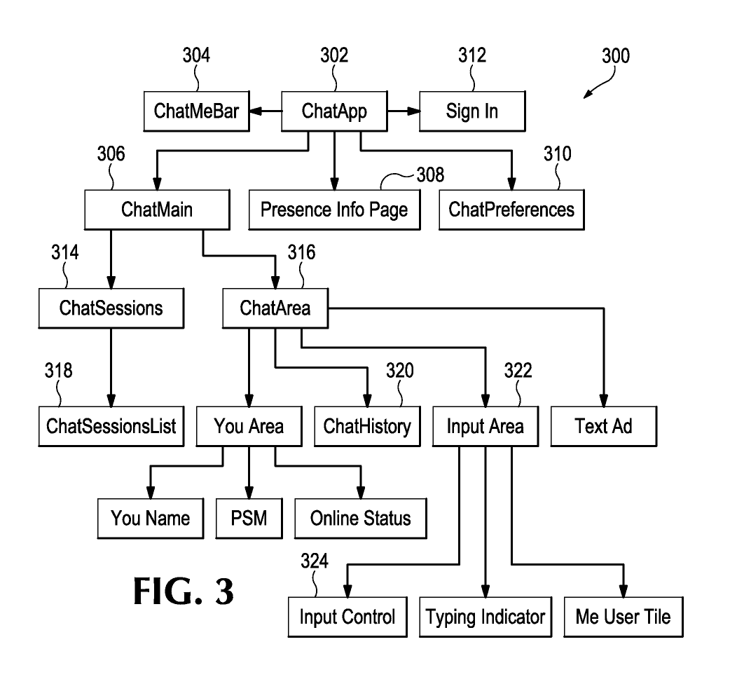

A processing device, e.g., processing device 104 of FIG. 1, may use these modules to dynamically generate at run time an abstract tree structure including at least a portion of the modules that define logic components of the tailored application and to build a user interface for the tailored application by concatenating user interface elements received from the at least a portion of the modules included in the abstract tree structure. Component tree module 231 may be a tree object comprising tree node objects 215. Application development toolkit 200 may store or keep a reference to the tree created by component tree module 231 in a predetermined location, e.g., memory 106. Tree node 215 may comprise APIs, e.g., appendChild( )(described below) that may be used by the processing device 104 to dynamically build the component tree at run time. For example, the chat app 300 may build the chat component tree shown in FIG. 3 at run time or startup, as explained in more detail below.

Tailored applications are built from various user interfaces, data components, and logic components. The World Wide Web Consortium (W3C) Document Object Model (DOM) standard is a platform and language-neutral interface that allows programs and scripts to dynamically access and update the content, structure, and style of a document that make up the user interface. Under DOM, an HTML tree may be used to describe the relationship between various user interface elements. Component tree module 231, in contrast, may be configured to build and maintain an abstract tree structure of logic components that define the tailored application. Logic components, in this context, may be modules that define the behavior or functionality of a tailored application. Logic components may include any of the modules that the present disclosure describes in detail below, either alone, or in combination with other modules.

An exemplary logic component tree may be built from tree nodes 215, e.g., JavaScript objects. FIG. 3 is a component tree of a chat application 300 that includes logic components 302, 304, 306, and so on. Each of these logic components includes a corresponding user interface element or representation. User interface elements such as HTML or DOM elements, by contrast, graphically represent the application, and not individual logic components that define the behavior or functionality of the application. Application development toolkit 200 polls the logic components for their user interface elements at various times, e.g., startup or during scene changes. The user interface elements may change dynamically and may include user data or information, e.g., the chat application 300 shown in FIG. 3 keeps a list of active chat sessions in logic component ChatSessions 314.

At run time, the processing device 104 may execute the application to build the tree structure based on various parameters, such as a plurality of entry points to the application, a universal reference locator for the application, a state of the OS associated with the application, a state of the application, an action of a user, a hardware configuration of the computing device, or user data, e.g., user name or chat history.

Entry points, as used herein, may refer to specific locations within an application where an end user enters the application experience. An entry point may be represented within the user interface using various elements, e.g., an image, title string, descriptive string, and the like. An entry point also may have an associated category that determines a location in the user interface where the entry point appears. Each application may have multiple entry points. At a minimum, an application may have a single entry point that opens the application's main view or main scene. An application may be launched with the same entry point from multiple locations within the OS.

Since each of the modules is self-contained, each module may be configured to implement its own policies for DOM caching depending on the context in which the processing device instantiates the module. Each of the modules the present disclosure describes herein may have different lifetime stages including construct, initialization, or shutdown and may have different user interface stages including initialize the user interface and shutdown the user interface. Each of the modules may attach or detach component nodes 215 from component tree module 231 based on lifetime, user interface stages, and the like. Examples of component node 215 APIs to manage attaching and detaching from the tree include appendChild( )and removeChild( ) described in more detail below.

Component module 230 may be an object configured to be used as a prototype to other objects to create the logic components used by component tree module 231 to build and maintain the tree structure. Component module 230 may be configured to handle logic components of the application, e.g., DOM lifetime, commands, and the like. Component module 230 may be configured to only directly communicate with children, example ChatApp 302 and ChatMeBar 304 (FIG. 3) or may be configured to communicate with other modules in the application through an application programming interface (API), using data binding, events, services, or the like. Component module 230 may be a type of object in JavaScript termed a “mixin” object that provides a predetermined functionality to be inherited or reused by another object.

Component module 230 may be built from objects as follows:

Jx.mix(Jx.Component, Jx.Base);
Jx.mix(Jx.Component, Jx.Attr);
Jx.mix(Jx.Component, Jx.TreeNode);
Jx.mix(Jx.Component, Jx.EventTarget);

Component module 230 may have the following properties:

void initComponent( ) - Initialize the component
void shutdownComponent( ) - Shut down the component
void onShutdownComponent( ) - Default implementation for the
“onShutdownComponent” callback
string getHtml( ) - Returns the HTML string fragment
string getCss( ) - Returns the CSS string fragment
void after InitUI( ) - Default implementation for the
“afterInitUI” callback
void beforeShutdownUI( ) - Default implementation for the
“beforeShutdownUI” callback

Tree node module 215 may be an object configured to implement a tree node with parent and children. Each node in a tree may have none or many children nodes, and at most, one parent node. Put differently, a node that has a child node is a parent node.

Tree node module 215 may have the following properties:

Object getParent( ) - Returns the parent node
bool isRoot( ) - Returns true if the node is the root (has no parent)
Object getChild(index) - Returns the child with the given index
Number getChildrenCount( ) - Returns the number of children
bool hasChildren( ) - Returns true if it has children
void appendChild(child) - Appends a node to the children array
void append( ) - Appends multiple nodes to the children array
void removeChildAt(index) - Removes the child at the given index
void removeChild(obj) - Removes the given child
void forEachChild(fn, obj) - Calls obj.fn( ) for each child

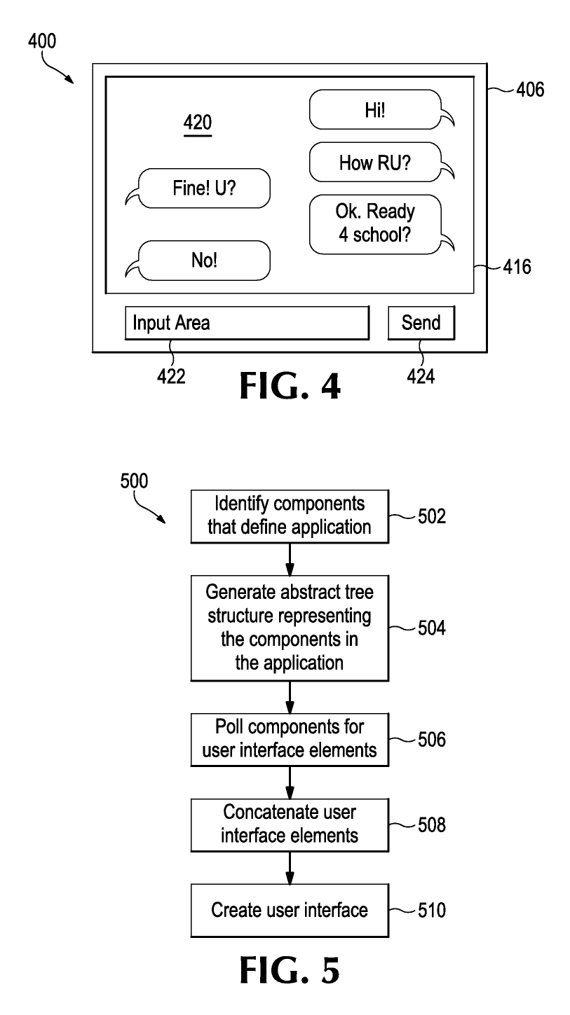

FIG. 3 is an abstract tree structure associated with the exemplary application development toolkit. FIG. 4 is an illustration of a user interface for the abstract tree structure shown in FIG. 3. Referring to FIGS. 2-4, component tree module 231 may create an abstract tree structure of the logic components for a tailored application, e.g., chat application 300 shown in FIG. 3. The abstract tree structure shown in FIG. 3 shows the relationships between the logic components of an application, e.g., a chat application. The abstract tree structure for chat application 300 includes a root node ChatApp 302 and children nodes corresponding to application modules ChatMeBar 304, ChatMain 306, Presence Info Page 308, ChatPreferences 310, and SignIn 312. Application module ChatMain 306, in turn, includes children nodes corresponding to application modules ChatSessions 314 and ChatArea 316. Application module ChatSessions 314 includes a child node corresponding to application module ChatSessionsList 318, and so on. The tree structure associated with chat application 300 includes logic components, e.g., Sign In 312, ChatMain 306, and the like. These logic components represent the manner in which the chat application 300 functions and operates, and the relationship between modules of the application. The function, operation, and relationship of the logic components, in turn, may result in the user interface 400 for the chat application 300 shown in FIG. 4.

Referring to FIG. 4, the user interface 400 illustrate a main portion 406 of the chat application 300 represented by ChatMain 306 in the abstract tree structure. The main portion 406 includes a chat area 416 including chat history 420, input area 422, input control area 424, respectively represented by ChatHistory 320, Input Area 322, and Input Control 324 in the abstract tree structure.

Referring back to FIG. 2, exemplary application development toolkit 200 includes a global module 202 that may be configured to serve as a main entry point to the toolkit 200. Global module 202 may be a programming construct coded in a scripting language as a “singleton” class that is restricted to one object at a time. Global module 202 may be configured to act as a namespace for the toolkit 200 and may have the following properties:

string ver - the toolkit version
bool debug - true if the object is part of the debug build
TreeNode root - the component tree root

As previously indicated, core modules 204 may be those modules used to create tailored applications. In addition to tree node module 215, core modules 204 may include object oriented module 210, attribute module 211, base module 212, hash module 213, event manager module 214, event target module 216, DOM module 217, general utilities module 218, and/or debug module 219.

Object oriented module 210 may include methods configured to aid in defining prototypal object inheritance and module reuse through the use of any of a variety of methods or techniques including, e.g., using a “mixin” object in JavaScript. These methods may allow the copying or augmenting of properties from a source module to a destination module. These methods may also allow for prototypal inheritance by allowing one constructor A to add its own functions to a constructor B without changing other modules that may use constructor B as a prototype.

Object oriented module 210 may have the following properties:

void mix(dest, src) - Copies all properties from source to destination. May
be used to build complex prototype objects from simple objects.
void augment(dest, src) - Copies all properties from source to destination
prototype.
May be used to define constructors from “mixin” objects.
void inherit(obj, base) - Helper for prototypal inheritance as described
above.

Attribute module 211 may be an object configured to store attributes. Attribute module 211 may be an object that stores attributes, e.g., default value, set function, get function, valid function, and/or change notification function. Attribute module 211 may support one- or two-way binding with other attributes. Attribute module 211 may have the following properties:

void initAttr( ) - Initializer
bool isAttrInit( ) - Returns true if the Attr object is initialized
void shutdownAttr( ) - Shutsdown the Attr object
void resetAttr( ) - Undefine (remove) all attributes
void attr(name, desc) - Define an attribute
bool setAttr(name, value) - Sets the value of attribute ‘name’
var getAttr(name) - Returns the value of attribute ‘name’
void bindAttr(srcAttr, destObj, destAttr) - Binds one way this.srcAttr
and destObj.destAttr
void bindAttr2Way(srcAttr, destObj, destProp) - Binds two way
this.srcAttr and destObj.destAttr
object getAttrValues( ) - Returns an object containing the attributes and
the values as regular object properties

Base module 212 may be an object configured to provide initialization and shutdown functionality. Base module 212 may be an object having the following properties:

string name - Object's name or null
void initBase( ) - Initialize the base object
void shutdownBase( ) - Shut down the base object
bool isInit( ) - Returns true if the base object is initialized
bool isShutdown( ) - Returns true if the base object is shut down

Hash2 module 213 may be an object configured to implement a hash table. Attribute module 211 may use hash2 module 213 to store attributes and may have the following properties:

Object _data - Object used as storage _data[key1][key2]
void set(key1, key2, value) - Sets value to _data[key1][key2]
void setAll(key1, obj) - Copy all properties from obj to _data[key1]
var get(key1, key2) - Returns _data[key1][key2]
bool has(key1, key2) - Returns true if _data[key1][key2] exists. key2 can
be missing
void remove(key1, key2) - Removes key2 from _data[key1]
void removeAll(key1) - Removes _data[key1]
void reset( ) - Removes all keys
void forEachKey1(fn, obj) - Calls obj.fn(key1) for each key1

Event manager module 214 may be an object configured to fire and handle events. Event manager module 214 may support routing, bubbling, and broadcasting and may have the following properties:

enum Stages = { Routing: 1, Direct: 2, Bubbling: 3, Broadcast: 4 } -
event stages
void addListener(target, type, fn, context) - Adds a listener on a target
void removeListener(target, type, fn, context) - Removes a listener from a
target
void fire(source, type, data, options) - Fires an event on the source
void fireDirect(source, type, data) - Fires a direct event (no routing,no
bubbling) on a source
void broadcast(type, data, root) - Broadcasts an event starting from the
root

Event target module 216 may be an object configured to simplify and listen to events and may have the following properties:

void on(type, fn, obj) - Adds an event listener
void detach(type, fn, obj) - Removes an event listener
void fire(type, data, options) - Fires an event
void fireDirect(type, data) - Fires a direct event

DOM module 217 may be a set of DOM utilities having the following properties:

bool hasClass(el, cls) - Returns true if ‘el’ has the class ‘cls’
void addClass(el, cls) - Adds the class ‘cls’ to ‘el’
void removeClass(el, cls) - Removes the class ‘cls’ from ‘el’
void addStyle(css) - Adds a style element to the document containing the
‘css’ string fragment

General utilities module 218 may be a collection of general utilities having the following properties:

string fnEmptyString( ) - Function that returns an empty string
void fnEmpty( ) - Empty function
bool isString(v) - Returns true if the given argument is a string
bool isNonEmptyString(v) - Returns true if the given argument is a
non-empty string
bool isObject(obj) - Returns true if the given argument is an object that
is not null or undefined

Debug module 219 may include an object including a set of debugging utilities for error handling. Debug module 219 may have the following properties:

void assert(condition) - In debug builds it throws an assert error if the
condition is false

Services modules 206 may be those modules that are optional to create tailored applications. Services modules 206 may include log module 220, hydration module 221, navigation module 222, storage module 223, activation module 224, timer module 225, and/or resources module 226.

Log module 220 may be an object configured to log objects, errors, builds, and the like. Log module 220 may have the following properties:

bool Jx.Log.enabled - Enable/disable logging
enum Levels = { Always: 0, Critical: 1, Error: 2, Warning: 3,
Informational: 4, Verbose: 5 }
Number level = Jx.Log.Levels.Error - Default log level
void write(level, msg) - Log a message with the given level
void always(msg) - Log a message with the “always” level
void critical(msg) - Log a message with the “critical” level
void error(msg) - Log a message with the “error” level
void warning(msg) - Log a message with the “warning” level
void info(msg) - Log a message with the “info” level
void verbose(msg) - Log a message with the “verbose” level

Hydration module 221 may be an object configured to send dehydration and rehydration events, i.e., saving state, suspending state, restoring state, or resuming state to other modules. Hydration module 221 may have the following properties:

void dehydrate(node) - Broadcasts the dehydrate event
void rehydrate(node) - Broadcasts the rehydrate event

Navigation module 222 may be an object configured to synchronize a universal reference locator hash with local memory, e.g., memory 106 shown in FIG. 1. The reference locator hash may be a key/value pair and may have the following properties:

Jx.mix (Jx.Navigation, Jx.Attr);
void init( ) - Initialize the navigation object
void shutdown( ) - Shutdown the navigation object
void addHashKey(key) - Adds the key to navigation and storage and bind
them 2way

Storage module 223 may be an object configured to store hydration data in attribute module 211. Storage module 223 may have the following properties:

Jx.mix(Jx.Storage, Jx.Attr);
void init( ) - Initialize the storage
void shutdown( ) - Shutdown the storage
void reset( ) - Reset (empty) the storage
void setItems(data) - Populate the storage from the given data object
void load( ) - Loads the persisted storage data into memory
void save( ) - Persists the storage data

Activation module 224 may be an object configured to mock or mimic entry points to other modules or objects, simulate events without being in the host, and maintain state information. Activation module 224 may have the following properties:

void init( ) - Initialize the activation object
void getState( ) - Returns the app activation state

Timer module 225 may be an object configured to set and maintain timers.

Resources module 226 may be an object configured to keep internationalization and localization information, e.g., localized strings in different languages.

As the present disclosure indicated previously, user interface module 208 may include modules responsible for the generation of user interfaces for tailored applications. In addition to component tree module 231 and component module 230, user interface modules 208 may include application module 232.

Application module 232 may be an object configured to manage the tailored application by containing navigation, storage, component tree root, and the like. Application module 232 may have the following properties:

void init( ) - Initialize the application object
void initUI(e) - Builds the UI from the component tree
void shutdown( ) - Shuts down the Application object
void shutdownUI( ) - Shuts down the application UI

FIG. 5 is a simplified flow diagram illustrating a method 500 of generating an application using the exemplary application development toolkit shown in FIG. 1. Referring to FIGS. 1-5, at 502, the processing device 104 may identify components stored in a memory device of a computing device, e.g., memory device 106, which define a logic, e.g., behavioral or functional, structure of an application. The processing device 104 may instantiate the components at run time. The components may define methods, functions, or processes associated with the operation of the application. The components may be programming constructs such as modules or objects defined in any number of programming languages including scripting languages such as JavaScript, VB Script, Jscript, XUL, Ajax, and the like. The components may include, utilize, or be based on at least a portion of core modules 204, services modules 206, and user interface modules 208. At 504, the processing device 104 may generate, in memory device 106, an abstract tree structure representing the application and including at least a portion of the objects that define logic components for the application. The abstract tree structure may represent the relationships between the components, logic or otherwise, which define the application, as the disclosure describes in more detail above. The processing device 104 may build a user interface for the application based on the components represented in the tree structure. The processing device 104 may build the interface in a variety of manners, including the manner depicted in FIG. 5. At 506, the processing device 104 may request or poll each of the logic components in the abstract tree for their corresponding user interface strings, e.g., hypertext markup language (HTML) or Cascading Style Sheet (CSS) strings. The processing device 104 may concatenate the strings received from the logic components in response to the request at 508 and may create the user interface for the application at 510, which, in turn, may be read or parsed by an HTML engine (not shown separately from computing device 102) and composed into audible or visible web pages. Doing so improves performance by allowing the components to build and destroy their individual user interface components in response to various parameters, including entry points, universal reference locator for the application, state of an operating system associated with the application, state of the application, user action, user data, or hardware configuration. The components' ability to detach and attach from the tree structure in response to events or state avoids complex DOM trees that adversely may affect performance.

A person of ordinary skill in the art will recognize that they may make many changes to the details of the above-described exemplary application development toolkit without departing from the underlying principles. Only the following claims, therefore, define the scope of the exemplary application development toolkit.

1. An apparatus, comprising:
a memory device configured to store programming constructs of a scripting language, the programming constructs being configured to define an application; and
a processing device configured to:
dynamically generate, in the memory device, an abstract tree structure including at least a portion of the programming constructs that define logic components of the application; and
build a user interface for the application by concatenating user interface components received from the at least a portion of the programming constructs included in the abstract tree structure.

2. The apparatus of claim 1, wherein the processing device is further configured to build the user interface by concatenating hypertext markup language or cascading style sheet strings from the at least a portion of the programming constructs in the abstract tree structure.

3. The apparatus of claim 1, wherein the processing device is further configured to enable simulation of distinct entry points to each of the programming constructs in response to the abstract tree structure.

4. The apparatus of claim 1, wherein the processing device is further configured to enable mocking at least one dependency of at least one of the programming constructs to another of the programming constructs.

5. The apparatus of claim 1, wherein the processing device is further configured to enable testing functionality of at least one of the programming constructs without testing functionality of the application.

6. The apparatus of claim 1, wherein the processing device is further configured to selectively attach programming constructs to the abstract tree structure in response to the application.

7. A memory device having instructions stored thereon that, in response to execution by a processing device, causes the processing device to perform operations comprising:
loading programming constructs of a scripting language configured to generate an application;
dynamically generating, in the memory device, an abstract tree structure including at least a portion of programming constructs that define logic components of the application; and
building a user interface for the application by concatenating user interface components from the at least a portion of the programming constructs in the abstract tree in response to the application.

8. The memory device of claim 7, wherein execution of the instructions causes the processing device to perform operations further comprising building the user interface by concatenating hypertext markup language or cascading style sheet strings from the at least a portion of the programming constructs.

9. The memory device of claim 7, wherein execution of the instructions causes the processing device to perform operations further comprising enabling simulation of distinct entry points to each of the programming constructs in response to the abstract tree structure.

10. The memory device of claim 7, wherein execution of the instructions causes the processing device to perform operations further comprising enabling mocking at least one dependency of at least one of the programming constructs to another of the programming constructs.

11. The memory device of claim 7, wherein execution of the instructions causes the processing device to perform operations further comprising enabling testing functionality of at least one of the programming constructs without testing functionality of the application.

12. The memory device of claim 7, wherein execution of the instructions causes the processing device to perform operations further comprising selectively attaching programming constructs to the abstract tree structure in response to the application.

13. A method, comprising:
identifying objects stored in a memory device of a computing device, the objects enabling generation of an application;
generating, in the memory device, a tree structure representing the application and including at least a portion of the objects that define logic components for the application; and
building a user interface for the application in response to the tree structure.

14. The method of claim 13, wherein building the user interface further comprises concatenating strings from the at least a portion of the logic objects.

15. The method of claim 13, further comprising:
enabling simulation of a plurality of entry points to each of the logic objects in the application in response to the tree structure.

16. The method of claim 13, further comprising:
enabling mocking at least one dependency of at least one of the logic objects to another of the logic objects.

17. The method of claim 13, further comprising:
testing functionality of at least one of the logic objects without testing functionality of the application.

18. The method of claim 13, further comprising:
selectively attaching at least one of the logic objects to the tree structure in response to a state of the at least one of the logic objects.

19. The method of claim 18, wherein the state comprises saving state, suspending state, restoring state, or resuming state.

20. The method of claim 13, further comprising building the tree structure in response to:
a plurality of entry points to the application;
a universal reference locator for the application;
a state of an operating system associated with the application;
a state of the application;
an action of a user;
user data; or
a hardware configuration of the computing device.
